(19) United States
(12) Patent Application Publication
(10) Pub. No.: US 2023/0059269 A1
(43) Pub. Date: Feb. 23, 2023

(54) AUTOMATED MECHANICAL SHAPING OF COMPOSITE MATERIALS

(71) Applicant: Cytec Industries Inc., Princeton, NJ (US)

(72) Inventor: Richard Hollis, Heanor (GB)

(73) Assignee: Cytec Industries Inc., Princeton, NJ (US)

(21) Appl. No.: 17/793,363

(22) PCT Filed: Jan. 13, 2021
(86) PCT No.: PCT/US2021/013144

§ 371 Date: Jul. 15, 2022

Related U.S. Application Data
(60) Provisional application No. 62/961,694, filed on Jan. 15, 2020.

(51) Int. Cl. B29C 70/38; B29C 70/34; B29C 70/54

(52) U.S. Cl. CPC B29C 70/38; B29C 70/345; B29C 70/342; B29C 70/542; B29C 2793/0081

(57) ABSTRACT

Disclosed herein are fully automated methods for shaping a composite material.

### BACKGROUND

Fiber-reinforced polymer composite materials have widespread use in many industries (including aerospace, automotive, marine, industrial, construction, and a wide variety of consumer products), often being preferred because they are lightweight while still exhibiting high strength and corrosion resistance, particularly in harsh environments. Fiber-reinforced polymer composite materials are typically made from either pre-impregnated materials or from resin infusion processes.

Pre-impregnated materials, or “prepregs” generally refer to fibers (such as carbon fibers) impregnated with a curable matrix resin (such as epoxy). The resin content in the prepreg is relatively high, typically 40%-65% by volume. Multiple plies of prepregs may be cut to size for laying up, then subsequently assembled and shaped in a molding tool. In the case where the prepreg cannot be easily adapted to the shape of the molding tool, heating may be applied to the prepreg in order to gradually deform it to the shape of the molding surface. Fiber-reinforced polymer composite materials may also be made by liquid molding processes that involve resin infusion technologies. In a typical resin infusion process, dry bindered fibers are arranged in a mold as a preform, followed by injection or infusion directly in-situ with liquid matrix resin. After injection or infusion, the resin-infused preform is cured to provide a finished composite article.

For both types of material, the process for three-dimensional shaping (or molding) of the composite material is critical to the appearance, properties and performance of the final molded product. It is still customary to shape preforms into detailed geometries using a hand layup process, which is time consuming and often results in significant part-to-part variation. While other, less manual, methods also exist for shaping composite materials (such as vacuum forming methods which may also employ pins, robots and/or actuators to aid in part formation), such methods have their own disadvantages and shortcomings. For example, vacuum methods are considered “offline”, because formation and curing occur in different process steps. In addition, such methods are often time consuming and do not take the rheological behavior and cure characteristics of the composite materials into consideration. In addition, the product of such processes is still prone to wrinkling and other imperfections.

### SUMMARY

A new, fully automated method for shaping a composite material is disclosed herein, which not only addresses shortcomings of methods known in the art in terms of lack of automation and utilization of existing infrastructure and equipment, but also provides a very quick and consistent means for shaping composite materials to deliver parts having extremely low part-to-part variability and excellent surface properties.

Accordingly, in one aspect, the present teachings provide fully automated methods for shaping a composite material, the methods comprising:

(a) optionally machining at least one composite material layer having a top surface and a bottom surface to a pre-determined pattern;

(b) placing a bottom frame defining a perimeter on a conveyor using a first robotic arm equipped with end effectors configured to grasp a diaphragm or a frame, wherein the conveyor passes through a heating apparatus and a press tool;

(c) positioning a lower diaphragm having a top surface and a bottom surface against the bottom frame using the first robotic arm, such that the bottom surface of the lower diaphragm contacts the top of the perimeter of the bottom frame;

(d) positioning at least one composite material layer on the lower diaphragm using a second robotic arm equipped with an end effector configured to grasp the composite material layer, such that the bottom surface of the at least one composite material layer contacts a portion of the top surface of the lower diaphragm and the composite material layer is positioned within the perimeter defined by the bottom frame;

(e) placing a center frame defining the perimeter on the top surface of the lower diaphragm using the second robotic arm, such that the bottom of the perimeter of the center frame contacts the top surface of the lower diaphragm and the bottom frame and the center frame are in a stacked arrangement;

(f) positioning an upper diaphragm having a top surface and a bottom surface against the center frame using the second robotic arm, such that the bottom surface of the upper diaphragm contacts the top of the perimeter of the center frame;

(g) placing a top frame defining the perimeter against the upper diaphragm using the second robotic arm, such that the bottom of the perimeter of the top frame contacts the top surface of the upper diaphragm and the center frame and the top frame are in a stacked arrangement, thus forming a pocket between the lower and upper diaphragms which houses the at least one composite material layer;

(h) removing air from the pocket, thereby forming a layered structure, such that the at least one composite material layer is held stationary within the pocket until heat, force, or a combination thereof, is applied thereto;

(i) conveying the layered structure into the heating apparatus, such that the layered structure is heated to a temperature sufficient to either lower the viscosity of the composite material or soften the diaphragms;

(j) conveying the layered structure into the press tool comprising a male mold and a corresponding female mold separated by a gap, wherein the male mold and the female mold each independently have a non-planar molding surface;

(k) compressing the layered structure between the male mold and the female mold by closing the gap between the male mold and the female mold;

(l) maintaining the male mold and the female mold in a closed position until the viscosity of the layered structure reaches a level sufficient to maintain a molded shape, such that a shaped structure is formed;

(m) opening the gap between the male mold and the female mold, and conveying the shaped structure out of the press tool;

(n) removing one or more of the top frame, the bottom frame or the center frame from the diaphragms using a third robotic arm equipped with an end effector configured to grasp a frame; and

(o) optionally placing, using the third robotic arm, one or more of the top frame, the bottom frame or the center frame onto a second conveyor which carries frames to the vicinity of the first robotic arm.

In some embodiments, multiple composite material layers are machined to a pre-determined pattern; and the multiple layers are positioned in a stacked arrangement on the top surface of the lower diaphragm using the second robotic arm.

In some embodiments, step (h) comprises applying a vacuum pressure between the upper diaphragm and the lower diaphragm.

In some embodiments, the male mold and the female mold are maintained at a temperature above ambient temperature, e.g., a temperature above 100° C.

In some embodiments, step (k) comprises partially closing the gap between the male mold and the female mold such that a smaller gap is formed between the molds, which smaller gap is subsequently closed after a specific time or viscosity is reached.

In some embodiments, step (1) is carried out until the viscosity of the composite material is less than 1.0×10⁸ m Pa.

In some embodiments, the male mold and female mold are maintained in a closed position for between about 10 seconds and about 30 minutes.

In some embodiments, the shaped structure is removed from the tool while it is above the softening temperature of the composite material.

In some embodiments, steps (n) and (o) comprise:

removing the top frame from the diaphragms and placing the top frame onto the second conveyor using the third robotic arm;

removing the center frame and the diaphragms from the bottom frame, depositing the diaphragms with the shaped structure therein into a receptacle, and placing the center frame onto the second conveyor using the third robotic arm; and

placing the bottom frame onto the second conveyor using the third robotic arm.

In some embodiments, the first robotic arm, the second robotic arm and the third robotic arm operate concurrently and continuously for a fixed time period, such that the method provides continuous production of shaped structures during the fixed time period.

In some embodiments, the upper diaphragm and the lower diaphragm are each independently selected from a film comprising one or more layers, each independently selected from a rubber layer, a silicone layer and a plastic layer or an elastic layer.

In some embodiments, the heating apparatus is a contact heater or an IR heater.

In some embodiments, the composite material comprises structural fibers of a material selected from aramid, high-modulus polyethylene (PE), polyester, poly-p-phenylene-benzobisoxazole (PBO), carbon, glass, quartz, alumina, zirconia, silicon carbide, basalt, natural fibers and combinations thereof.

In some embodiments, the composite material comprises a binder or matrix material selected from thermoplastic polymers, thermoset resins, and combinations thereof.

### BRIEF DESCRIPTION OF THE DRAWINGS

FIG. 1 is a flow diagram, visually depicting an exemplary method in accordance with the present teachings.

### DETAILED DESCRIPTION

In view of the potential drawbacks of composite material processing, including processing time, part-to-part variation and visual imperfections, there still exists a need to develop faster, improved and more reliable assemblies and processes. This is particularly true for automotive parts that not only require visual acceptance, but also may be utilized in assembly lines requiring dozens or even hundreds of parts per minute. While finding the proper balance between visual acceptance and speed of production, it is also desirable take full advantage of existing equipment (e.g., metal stamps or presses). However, traditional metal stamping equipment typically results in an imperfect, uneven surface when used directly on composite materials. The present disclosure provides methods for shaping composite materials using an automated mechanical thermoforming process, which is capable of using metal stamping tools to quickly and consistently produce formed parts having extremely low part-to-part variability and excellent surface properties.

### Automated Process for Shaping Composite Materials

The present teachings include automated methods for shaping composite materials.

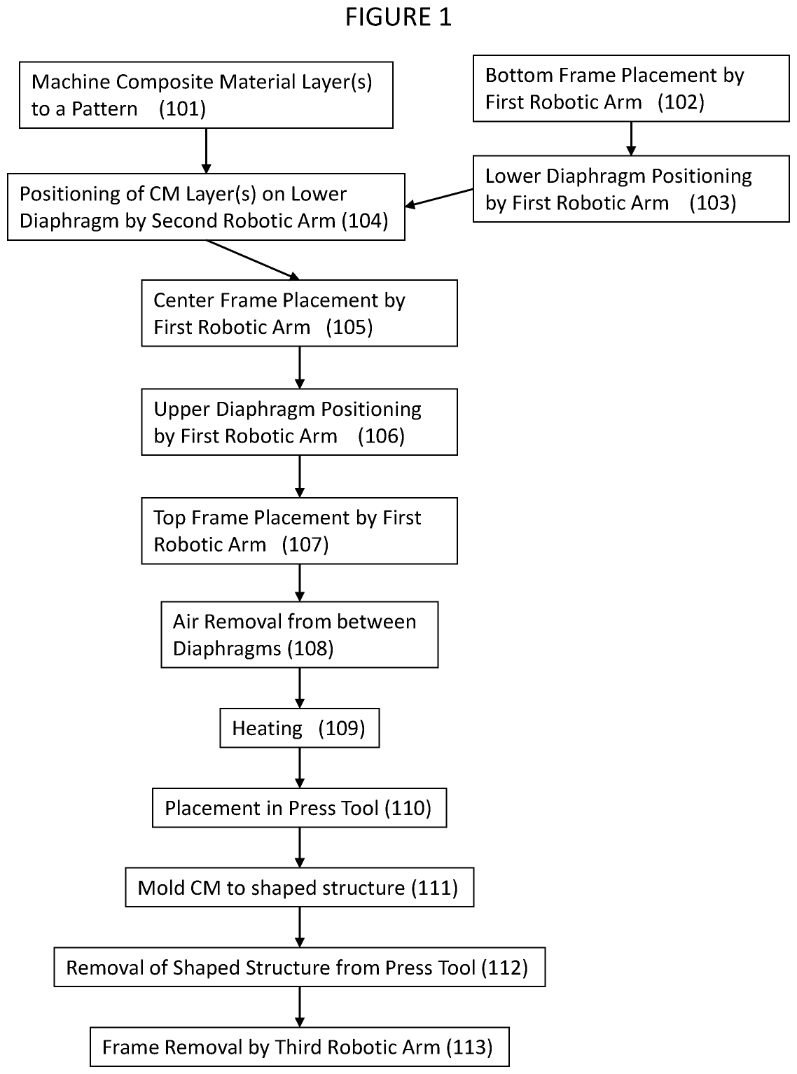

Referring now to FIG. 1, the method may optionally begin with one or more composite material layers (also called “plies”) being machined to a pre-determined pattern (101). For example, a computer-driven cutter may be employed to minimize waste around the periphery of the shaped structure. In this manner, computer algorithms can be used, e.g., to nest or otherwise position various shapes to form multiple layers or plies from one large piece of composite material—and therefore maximize material usage. The position of the cut plies can then be translated, e.g., by the computer, to a robot for placement within the frame structure defined herein.

In some embodiments, the composite material layer(s) are substantially planar. As used herein, the term “substantially planar” refers to a material that has one plane that is measurably larger than the other two planes (for example, at least 2, 3, 4 or 5 times larger, or more). In some embodiments, the substantially planar material has thickness variation along the largest plane. For example, the composite material may include reinforcement materials such as pad-ups (i.e., localized increases in the quantity of plies) or ply drops (i.e., localized decreases in the quantity of plies), material changes, and/or areas where the composite transitions, e.g., to fabric. In other embodiments, the substantially planar material exhibits minimal thickness variation along the area of the composite material. For example, the term substantially planar can mean that the composite material has a global thickness variation of no greater than +/−15% over 90% of the area. In some embodiments, the thickness variation is no greater than +/−10% over 90% of the area. Substantially planar is not intended to denote a perfectly flat material, but also includes materials that have slight variations in concavity and/or convexity.

A first robotic arm equipped with end effectors configured to grasp a diaphragm or a frame is utilized to place a bottom frame on a conveyor (102). This conveyor passes through a heating apparatus and a press tool, such that the assembled frame will travel on the conveyor through the various stages of shaping. The bottom frame defines a perimeter which maintains the shape of the diaphragms, e.g., by the positioning of clamps or other fastening means at predetermined intervals around the perimeter. Such frames can be manufactured based on the size and shape of the composite material to be molded. Optionally, pre-manufactured structural support frames are known in the art for use with conventional metal or composite press tools (e.g., from manufacturers such as Langzauner or Schubert).

The first robotic arm then positions a lower diaphragm having a top surface and a bottom surface against the bottom frame (103). The lower diaphragm is positioned such that its bottom surface contacts the top of the perimeter of the bottom frame. The movement of the bottom frame and the lower diaphragm can occur before, simultaneously with, or after the machining of the composite material layers. In some embodiments, these two steps occur simultaneously or substantially simultaneously such that the method proceeds in the least amount of time possible. The diaphragms are held by a dispenser in the vicinity of (i.e., within reach of) the first robotic arm. The diaphragm dispenser, for example, may be an automated dispenser which measures and cuts the upper and lower diaphragms to a pre-determined size from a roll of diaphragm material. In some embodiments, the first robot arm takes the lower diaphragm and the upper diaphragm (as described below) from different sides of the dispenser, for example when the top surface and the bottom surface of the diaphragms are different.

A second robotic arm equipped with an end effector configured to grasp the composite material layer then positions one or more of the composite material layers on the lower diaphragm (104). The composite material layer is positioned within the perimeter defined by the bottom frame. It is also positioned such that the bottom surface of the composite material layer contacts a portion of the top surface of the lower diaphragm. In some embodiments, multiple composite material layers are machined to a pre-determined pattern; and these multiple layers are positioned in a stacked arrangement on the lower diaphragm as described. It is understood that, in such stacked arrangement, the first composite material layer placed may contact the lower diaphragm, and the subsequently added layers will contact the previously placed layer, the lower diaphragm or both.

The second robotic arm then places a center frame on the top surface of the lower diaphragm (105). The center frame is chosen such that it defines the same perimeter as the bottom frame. The center frame is placed such that the bottom of the perimeter of the center frame contacts the top surface of the lower diaphragm and such that the bottom frame and the center frame are in a stacked arrangement. In some embodiments the center frame may include a means for removing air, for example a vacuum inlet or other valve. The vacuum inlet, if present, is connected to a vacuum source (e.g. a vacuum pump).

The second robotic arm then positions an upper diaphragm having a top surface and a bottom surface against the center frame (106). The upper diaphragm is positioned such that the bottom surface of the upper diaphragm contacts the top of the perimeter of the center frame. The second robotic arm then places a top frame against the upper diaphragm (107). The top frame is also chosen such that it defines the same perimeter as the bottom frame. The top frame is placed such that the bottom of the perimeter of the top frame contacts the top surface of the upper diaphragm and such that the center frame and the top frame are in a stacked arrangement. This arrangement forms a pocket between the lower and upper diaphragms which houses the composite material layer(s). In some embodiments, the pocket that houses the composite may be a sealed pocket, e.g., an airtight sealed pocket, whereby the top, center and bottom frames are disposed about the entire periphery of the composite material layer(s) and impede air or contaminants from entering the pocket.

Air is then removed from the pocket, thereby forming a layered structure, such that the at least one composite material layer is held stationary within the pocket until heat, force, or a combination thereof, is applied thereto (108). In some embodiments, vacuum pressure may be desired to remove air from the pocket. The use of vacuum pressure can act to extract the majority of residual air, which may hinder molding performance, thus minimizing deformation or wrinkling of the composite material layer (or its components). The use of vacuum pressure may also aid in maintaining fiber alignment, provide support to the materials during the process and during shaping, and/or maintain desired thickness of the layer(s) at elevated temperatures. The term “vacuum pressure” as used herein refers to vacuum pressures of less than 1 atmosphere (or less than 1013 mbar). In some embodiments, the vacuum pressure between the diaphragms is set to less than about 1 atmosphere, less than about 800 mbar, less than about 700 mbar, or less than about 600 mbar. In some embodiments, the vacuum pressure between the diaphragms is set to about 670 mbar. At this point, whether by vacuum or by other means, the composite material layer is firmly held between the diaphragms, such that it is stationary until the application of heat and/or force. Such stationary structure can be advantageous, for example, because the composite material layer(s) held within the layered structure is not only maintained stationary in its location with sufficient tension across its X and Y axes, but it is also indexed. That is to say, the second robotic arm places the composite material layer in a specific position along the X and Y axis between the diaphragms. This indexed layered structure may then be placed in a specific position in the press tool (as described in more detail hereinbelow), such that the press tool consistently engages a predetermined area of the composite material layer(s). Multiple copies of a molded product may thus be formed without the need to index each composite material blank individually.

The layered structure is then conveyed (i.e., via the conveyor) into the heating apparatus (109). The structure remains in the heating apparatus heated to a temperature sufficient to either lower the viscosity of the composite material or soften the diaphragms. This heating apparatus can be any heater that can be used in the formation or molding of metal or composite material products, for example, a contact heater or an infrared (IR) heater. In some cases this pre-heating softens the diaphragms, e.g., so that they are more pliable during formation of the final molded product. In some cases, this pre-heating brings the composite material layer held within the layered structure to a desired viscosity or temperature. Pre-heating may occur in a heating apparatus heated to a temperature of above about 75° C., 100° C., 125° C., 150° C., 175° C., 200° C. or even higher. This temperature can be adjusted, for example, depending upon the identity of the diaphragms and/or components in the composite material. Such pre-heating is advantageous, for example, if it is desired to minimize or eliminate heating of the press tool and/or to minimize the amount of time that the layered structure resides within the press tool.

The layered structure is then conveyed into the press tool (110). In the context of the present teachings, the press tool includes a male mold and a corresponding female mold separated by a gap. Each mold has a non-planar molding surface. In some embodiments, a mold release agent may be added to the male mold, the female mold, or both. Such mold release agent may be helpful, e.g., for removing the shaped part from the mold while still at temperatures above ambient temperature. The molding surfaces are fixed, i.e., not reconfigurable. The molding surfaces are also typically matched, i.e., the male mold corresponding approximately to the opposite of the female mold; and in some embodiments may be perfectly matched. However, in some embodiments, the male and female molds are such that, when closed, the thickness between them varies. In certain embodiments, the layered structure is positioned in the gap at a specific, predetermined distance between the male mold and the female mold. In some embodiments, no vacuum pressure is applied to any portion of the press tool. In other embodiments, localized vacuum is applied to the tool surface, for example to remove entrapped air between the layered structure and the tool. In such embodiments, however, the vacuum is typically not used as a force to form the shape of the final molded product. The layered structure can be placed in the press tool manually or by automated means, e.g., using an automated shuttle.

The layered structure is then compressed between the male mold and the female mold, by closing the gap between the molds (111). In some embodiments, this is accomplished by partially closing the gap between the male mold and the female mold to form a smaller gap between the molds. This smaller gap is subsequently closed after a specific time or viscosity is reached. It is understood that “closing the gap” refers to compressing the molds such that a pre-determined final cavity thickness along the Z axis is obtained between them. Final cavity thickness can be adjusted, e.g., by controlling where the molds stop in relation to each other, and the choice of thickness can be made by the operator of the molds and will depend on the nature of the final molded product. In some embodiments, the final cavity thickness is substantially uniform, i.e., the process produces a two-sided molded final product with a thickness that varies by less than 5%. In some embodiments, the process produces a final molded product with a thickness that varies by less than about 4%, e.g., less than about 3%, less than about 2% or even less than about 1%. In other embodiments, the male and female tools may be configured to provide a cavity thickness that purposely varies across the X and Y axes.

In certain embodiments, the male mold and the female mold are maintained at a temperature above ambient temperature. For example, they may be maintained at a temperature of above about 75° C., 100° C., 125° C., 150° C., 175° C., 200° C. or even higher. This temperature can be adjusted depending upon the identity (and the viscosity) of the components in the composite material. The molds, for example, can be maintained at a temperature above the softening point of the binder or matrix material used in the composite material. In some embodiments, the composite material comprises a thermoset material and molds are maintained at temperatures between about 100° C. and 200° C. In other embodiments, composite material comprises a thermoplastic material and the molds are maintained at temperatures above about 200° C. The binder or matrix material in the composite material is in a solid phase at ambient temperature (20° C.-25° C.), but will soften upon heating. This softening allows molding of the composite material in the press tool.

The male mold and the female mold are maintained in a closed position for a predetermined time to form a shaped structure. For example, in some embodiments, the molds are heated and maintained in a closed position until a desired viscosity or temperature is reached. In some embodiments, the molds are maintained in a closed position until the viscosity of the composite material is less than about 1.0×10⁸ m Pa. In some embodiments, the molds are heated and maintained in a closed position until the binder or matrix material begins to cross-link. In other embodiments, the molds are not heated, but are maintained in a closed position for a period of time sufficient for the material to maintain a molded shape. Molds may be maintained in a closed position, e.g., for between about 5 seconds and about 60 minutes, for example, for between about 10 seconds and about 30 minutes or between about 15 seconds and about 15 minutes. The length of time that the molds are maintained in a closed position will depend upon a number of factors, including the identity of the composite material and the temperature of the molds.

In certain embodiments, the male mold is driven through the layered structure, while the female mold remains static. In other embodiments, the female mold does not remain static, but moves at a rate that is slower than the male mold (such that the male mold still acts predominantly as the forming surface). In still other embodiments, both molds move at approximately the same rate of speed to close the gap between the molds. The molds are driven at a rate and to a final pressure sufficient to deform/mold the composite material. For example, the molds may be driven at a rate of between about 0.4 mm/s and about 500 minis, e.g., between about 0.7 mm/s and about 400 mm/s, e.g., between about 10 mm/s and about 350 mm/s or between about 50 mm/s and 300 mm/s. Additionally, the molds may be driven to a final pressure of between about 100 psi and about 1000 psi, e.g., between about 250 psi and about 750 psi. In some embodiments, the molds are driven at a rate and to a final pressure that have been selected to control the thickness of the final molded product while avoiding the formation of wrinkles and the distortion of structural fibers. In addition, the molds may be driven at a rate and to a final pressure that have been selected to allow the rapid formation of final molded parts.

The gap between the male mold and the female mold is then opened, and the shaped structure is conveyed from the mold (112). The shaped structure may be cooled to below the softening temperature of the binder or matrix material while the shaped structure remains on the press tool. However, in some embodiments, the shaped structure is removed from the press tool before it cools to below the softening temperature of the binder or matrix material. When the binder or matrix material cools to below its softening temperature, the binder or matrix material returns to a solid phase and the composite material retains its newly formed geometry. If the composite material is a preform, such preform will hold its desired shape for subsequent resin infusion.

Once the shaped structure is conveyed from the mold, a third robotic arm equipped with an end effector configured to grasp a frame removes (e.g., separates) one or more of the frames from the diaphragms (113). In some embodiments, the third robotic arm places the removed frame onto a second conveyor, which carries frames to the vicinity of the first robotic arm. For examples, in some embodiments, the third robotic arm removes the top frame from the diaphragms and places the top frame onto the second conveyor; removes the center frame and the diaphragms from the bottom frame and deposits the diaphragms with the shaped structure therein into a receptacle, and placing the center frame onto the second conveyor; and places the bottom frame onto the second conveyor.

In this manner, the present invention can form a closed loop, providing continuous operation. For example, in some embodiments, the first robotic arm, the second robotic arm and the third robotic arm operate concurrently and continuously for a fixed time period, such that the method provides continuous production of shaped structures during the fixed time period. The method described herein, therefore, provides an effective and efficient means for producing complex three-dimensional composite structures having excellent surface characteristics in a fully automated fashion. Three-dimensional, shaped composite structures can be produced quickly, repeatedly and on a large-scale with little or no need for hand manipulation. For example, three-dimensional composite structures can be formed from substantially planar composite material blanks in extremely short, e.g., 1-10 minute, preferably less than 5 minute or even less than 3 minute, cycles. Such quick, repeatable processes are suitable for the manufacture of automotive parts and paneling, such as hoods, trunks, door panels, fenders and wheel wells.

### Diaphragm Materials and Diaphragm Structures

As used herein, the term “diaphragm” refers to any barrier that divides or separates two distinct physical areas. The diaphragms are flexible and may be either elastic or non-elastically deformable sheets of material. As used herein, the term “flexible” refers to a material capable of deformation without significant return forces. Flexible materials typically have a flexibility factor (the product of the Young's modulus measured in Pascals and the overall thickness measured in meters) of between about 1,000 N/m and about 2,500,000 N/m. Typically, diaphragm thickness ranges between about 10 microns and about 200 microns, for example, between about 20 microns and about 150 microns. Particularly advantageous diaphragms have a thickness of between about 30 microns and about 100 microns. In some embodiments, the material used to make the diaphragms is not particularly limited and can be, for example, rubbers, silicones, plastics, thermoplastics, or similar materials. In certain embodiments, however, the material used to make the diaphragms includes a film comprising one or more layers, each independently selected from a plastic layer or an elastic layer. The diaphragms may be comprised of a single material or may include multiple materials, e.g., arranged in layers. The upper diaphragm and the lower diaphragm of a diaphragm structure, for example, can each independently be selected from a film comprising one or more layers, each individual layer being the same as or different than the other layers in the diaphragm. Diaphragm material can be formed into a film using conventional casting or extrusion procedures. In some embodiments, the film is disposable. In other embodiments, the film is reusable.

The diaphragm material can also be chosen to have a number of properties, depending upon the desired function. For example, in some embodiments, the diaphragm is self-releasing. That is, the diaphragm can easily release from the final molded part and/or the molded assembly can easily release from the tooling. In other embodiments, the diaphragm is designed to temporarily (or lightly) adhere to the molded composite material. Such temporary adhesion may be advantageous to protect the final molded part, e.g., during subsequent processing, transport and/or storage. In still other embodiments, the diaphragm is designed to permanently adhere to the molded composite material. Such temporary adhesion may be advantageous to provide a permanent protective coating and/or paint coating to the final molded part. The diaphragm material may be chosen based on its specific physical properties. For example, in some embodiments, the material used to make the diaphragms has an elongation to failure of above 100%. In some embodiments, the material used to make the diaphragms has a melting temperature that is similar to (e.g., within 10° C. of) the molding temperature of the composite material.

In some embodiments, the diaphragms are permeable to air. In other embodiments, the diaphragms are impermeable to air, such that together they are able to form a sealed pocket. The sealed pocket impedes contaminants (e.g., air, particulates, oil, etc.) from entering the sealed pocket for a period of time. In some embodiments, the impermeable diaphragms form an airtight sealed pocket. As used herein, the term “airtight” refers to the ability of a material to hold a vacuum for the duration of the tooling process. This airtight sealed pocket is advantageous, for example, when a vacuum is used to place the upper and lower diaphragms in intimate contact with the composite material.

In some embodiments, one or both diaphragms may be replaced with a woven or non-woven veil. As used herein, the term “veil” refers to a thin mat of continuous or chopped polymer fibers. The fibers may be yarns or monofilaments of spun strands. Typically, veils are resin-soluble and can generally be woven (e.g., in a controlled arrangement) or non-woven (e.g., partially or completely random). The weight of the veil(s) used in connection with the present methods can vary, but are typically between about 5 g/m² and about 100 g/m² and the selection of veil weight can be determined based on the attributes of the composite material being shaped. For example, a more viscous binder or matrix material may require a heavier veil (or more than one veil), whereas a less viscous binder may utilize a lighter veil. Similarly, if the surface of the composite material is resin-rich, the veil can be selected such that the resin does not over-permeate the veil. The material used in the veil is not particularly limited, and can be any veil known for use in connection with composite materials. However, in some embodiments, the woven or non-woven veil comprises polyester fibers, carbon fibers, aramid fibers, glass fibers, or a combination thereof. In other embodiments, the woven or non-woven veil comprises fibers of resin-soluble polymers, such as those identified in US 2006/0252334 to LoFaro et al., which is incorporated herein by this reference.

In some embodiments, one or more of the diaphragms and/or veils are maintained on the shaped structure, either temporarily or permanently. For example, a temporary layer may be desired, e.g., for a release coating, whereas a permanent coating may be desired, e.g., for corona treatment or bonding of the diaphragm material to the molded part. The function of the diaphragms will depend on the diaphragm material used.

### Composite Materials

As used herein, the term “composite material” refers to an assembly of structural fibers and a binder or matrix material. Structural fibers may be organic fibers, inorganic fibers or mixtures thereof, including for example commercially available structural fibers such as carbon fibers, glass fibers, aramid fibers (e.g., Kevlar), high-modulus polyethylene (PE) fibers, polyester fibers, poly-p-phenylene-benzobisoxazole (PBO) fibers, quartz fibers, alumina fibers, zirconia fibers, silicon carbide fibers, other ceramic fibers, basalt, natural fibers and mixtures thereof. It is noted that end uses that require high-strength composite structures would typically employ fibers having a high tensile strength (e.g., 3500 MPa or 500 ksi). Such structural fibers may include one or multiple layers of fibrous material in any conventional configuration, including for example, unidirectional tape (uni-tape) webs, non-woven mats or veils, woven fabrics, knitted fabrics, non-crimped fabrics, fiber tows and combinations thereof. It is to be understood that structural fibers may be included as one or multiple plies across all or a portion of the composite material, or in the form of pad-ups or ply drops, with localised increases/decreases in thickness.

The fibrous material is held in place and stabilized by a binder or matrix material, such that alignment of the fibrous material is maintained and the stabilized material can stored, transported and handled (e.g., shaped or otherwise deformed) without fraying, unraveling, pulling apart, buckling, wrinkling or otherwise reducing the integrity of the fibrous material. Fibrous materials held by a small amount of binder (e.g., typically less than about 10% by weight) are typically referred to as fibrous preforms. Such preforms would be suitable for resin infusion applications, such as RTM. Fibrous materials may also be held by larger amounts of matrix materials (generally called “prepregs” when referring to fibers impregnated with a matrix), and would thus be suitable for final product formation without further addition of resin. In certain embodiments, the binder or matrix material is present in the composite material in an amount of at least about 30%, at least about 45%, at least about 40%, or at least about 45%.

The binder or matrix material is generally selected from thermoplastic polymers, thermoset resins, and combinations thereof. When used to form a preform, such thermoplastic polymers and thermoset resins may be introduced in various forms, such as powder, spray, liquid, paste, film, fibers, and non-woven veils. Means for utilizing these various forms are generally known in the art.

Thermoplastic materials include, for example, polyesters, polyamides, polyimides, polycarbonates, poly(methyl methacrylates), polyaromatics, polyesteramides, polyamideimides, polyetherimides, polyaramides, polyarylates, polyaryletherketones, polyetheretherketones, polyetherketoneketones, polyacrylates, poly(ester) carbonates, poly(methyl methacrylates/butyl acrylates), polysulphones, polyarylsulphones, copolymers thereof and combinations thereof. In some embodiments, the thermoplastic material may also include one or more reactive end groups, such as amine or hydroxyl groups, which are reactive to epoxides or curing agents.

Thermoset materials include, for example, epoxy resins, bismaleimide resins, formaldehyde-condensate resins (including formaldehyde-phenol resins), cyanate resins, isocyanate resins, phenolic resins and mixtures thereof. The epoxy resin may be mono or poly-glycidyl derivative of one or more compounds selected from the group consisting of aromatic diamines, aromatic monoprimary amines, aminophenols, polyhydric phenols, polyhydric alcohols, and polycarboxylic acids. The epoxy resins may also be multifunctional (e.g., di-functional, tri-functional, and tetra-functional epoxies).

In some embodiments, a combination of thermoplastic polymer(s) and thermoset resin(s) are used in the composite material. For example, certain combinations may operate with synergistic effect concerning flow control and flexibility. In such combinations, the thermoplastic polymers would provide flow control and flexibility to the blend, dominating the typically low viscosity, brittle thermoset resins.

1. A fully automated method for shaping a composite material, the method comprising:
optionally machining at least one composite material layer having a top surface and a bottom surface to a pre-determined pattern;
placing a bottom frame defining a perimeter on a conveyor using a first robotic arm equipped with end effectors configured to grasp a diaphragm or a frame, wherein the conveyor passes through a heating apparatus and a press tool;
positioning a lower diaphragm having a top surface and a bottom surface against the bottom frame using the first robotic arm, such that the bottom surface of the lower diaphragm contacts the top of the perimeter of the bottom frame;
positioning at least one composite material layer on the lower diaphragm using a second robotic arm equipped with an end effector configured to grasp the composite material layer, such that the bottom surface of the at least one composite material layer contacts a portion of the top surface of the lower diaphragm and the composite material layer is positioned within the perimeter defined by the bottom frame;
placing a center frame defining the perimeter on the top surface of the lower diaphragm using the second robotic arm, such that the bottom of the perimeter of the center frame contacts the top surface of the lower diaphragm and the bottom frame and the center frame are in a stacked arrangement;
positioning an upper diaphragm having a top surface and a bottom surface against the center frame using the second robotic arm, such that the bottom surface of the upper diaphragm contacts the top of the perimeter of the center frame;
placing a top frame defining the perimeter against the upper diaphragm using the second robotic arm, such that the bottom of the perimeter of the top frame contacts the top surface of the upper diaphragm and the center frame and the top frame are in a stacked arrangement, thus forming a pocket between the lower and upper diaphragms which houses the at least one composite material layer;
removing air from the pocket, thereby forming a layered structure, such that the at least one composite material layer is held stationary within the pocket until heat, force, or a combination thereof, is applied thereto;
conveying the layered structure into the heating apparatus, such that the layered structure is heated to a temperature sufficient to either lower a viscosity of the composite material or soften the diaphragms;
conveying the layered structure into the press tool comprising a male mold and a corresponding female mold separated by a gap, wherein the male mold and the female mold each independently have a non-planar molding surface;
compressing the layered structure between the male mold and the female mold by closing the gap between the male mold and the female mold;
maintaining the male mold and the female mold in a closed position until the viscosity of the layered structure reaches a level sufficient to maintain a molded shape, such that a shaped structure is formed;
opening the gap between the male mold and the female mold, and conveying the shaped structure out of the press tool;
removing one or more of the top frame, the bottom frame or the center frame from the diaphragms using a third robotic arm equipped with an end effector configured to grasp a frame; and
optionally placing, using the third robotic arm, one or more of the top frame, the bottom frame or the center frame onto a second conveyor which carries frames to a vicinity of the first robotic arm.

2. The method of claim 1, wherein:
multiple plies of substantially planar composite material are machined to a pre-determined pattern; and
the multiple plies are positioned in a stacked arrangement on the top surface of the lower diaphragm using the second robotic arm.

3. The method of claim 1, further comprising applying a vacuum pressure between the upper diaphragm and the lower diaphragm.

4. The method of claim 1, wherein the male mold and the female mold are maintained at a temperature above ambient temperature.

5. The method of claim 4, wherein the male mold and the female mold are maintained at a temperature above 100° C.

6. The method of claim 1, further comprising partially closing the gap between the male mold and the female mold such that a smaller gap is formed between the molds, which smaller gap is subsequently closed after a specific time or viscosity is reached.

7. The method of claim 1, wherein the male mold and the female mold are maintained in a closed position until the viscosity of the composite material is less than 1.0×10⁸ m Pa.

8. The method of claim 1, wherein the male mold and the female mold are maintained in a closed position for between 10 seconds and 30 minutes, inclusive.

9. The method of claim 1, wherein the shaped structure is removed from the tool while the shaped structure is above the softening temperature of the composite material.

10. The method of claim 1, further comprising:
removing the top frame from the diaphragms and placing the top frame onto the second conveyor using the third robotic arm;
removing the center frame and the diaphragms from the bottom frame, depositing the diaphragms with the shaped structure therein into a receptacle, and placing the center frame onto the second conveyor using the third robotic arm; and
placing the bottom frame onto the second conveyor using the third robotic arm.

11. The method of claim 10, wherein the first robotic arm, the second robotic arm and the third robotic arm operate concurrently and continuously for a fixed time period, such that the method provides continuous production of shaped structures during the fixed time period.

12. The method of claim 1, wherein the upper diaphragm and the lower diaphragm are each independently selected from a film comprising one or more layers, each individual layer being a rubber layer, a silicone layer, a plastic layer, or an elastic layer.

13. The method of claim 1, wherein the heating apparatus is a contact heater or an IR heater.

14. The method of claim 2, wherein the composite material comprises structural fibers of a material selected from aramid, high-modulus polyethylene (PE), polyester, poly-p-phenylene-benzobisoxazole (PBO), carbon, glass, quartz, alumina, zirconia, silicon carbide, basalt, natural fibers and combinations thereof.

15. The method of claim 14, wherein the composite material comprises a binder or matrix material selected from thermoplastic polymers, thermoset resins, and combinations thereof.
